(19) United States
(12) Patent Application Publication
(10) Pub. No.: US 2022/0159968 A1
(43) Pub. Date: May 26, 2022

(54) Liposomal Delivery System for Beauveria bassiana Strain GHA spores to bed bugs.

(71) Applicant: Justin Ash, Valley Center, CA (US)

(72) Inventor: Justin Ash, Valley Center, CA (US)

(21) Appl. No.: 17/530,267

(22) Filed: Nov. 18, 2021

Related U.S. Application Data
(60) Provisional application No. 63/116,223, filed on Nov. 20, 2020.

(51) Int. Cl. A01N 63/32; A01N 25/34

(52) U.S. Cl. CPC A01N 63/32; A01N 25/34

(57) ABSTRACT

A breakable pearl containing a spore that, when activated, produces a fungus that is fatal to bed bugs, and a protective cover that prevents water from reaching the spore and causing it to germinate prematurely. Pearls are sprayed onto floors and furniture, and the spores are released only when the pearls are broken by bed bugs walking across them. The pearls have a water-resistant outer cover and a fragile inner cover such that they can be crushed by bed bugs walking over them. The pearls can be applied through traditional sprayers or as infused on one side of adhesive tape. When a bed bug touches the pearl, it breaks and the spore attaches itself to the bed bug's oily skin. Since it takes up to two weeks for the fungus to kill the bed bug, it will infect other bed bugs before it dies.

### CROSS REFERENCE TO RELATED APPLICATIONS

This application claims priority back to U.S. Provisional No. 63/116,223, with a filing date of Nov. 20, 2020, the contents of which are incorporated by reference into this application.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of devices and methods for the prevention of bed bug infestations and elimination of existing bed bug infestations, and more specifically toward a method of killing bed bugs by infecting them with spores through a variety of means. One preferred embodiment calls for the Liposomal Delivery System for Beauveria bassiana Strain GHA spores, in which the deadly spores are delivered to bed bugs through a covered-pearl delivery system that selectively releases the spores when bed bugs come in contact with them. Another embodiment of the invention focusses on encapsulating a bed-bug-killing spore in a variety of substances to extend the life of the spore until a bed bug breaks the encapsulation, thereby infecting itself with the spore. In yet another embodiment, a dry formulation, including spores, is produced inside of two coatings, with an outer coating that is water soluble, and an inner coating that is contact-breakable, such that the product can be sprayed onto a surface, thereby removing the outer covering, and the product basically “hibernates” until a bed bug walks over the product, crushing the inner covering and releasing the spore onto the bed bug. This last embodiment gives the spore a “shelf life” of years.

One of the common nighttime rhymes many parents say to their children before they go to sleep is “Good night, sleep tight, don't let the bed bugs bite”. The ironic thing about this rhyme is that bed bugs have not been a major problem in most of the United States for the lifetime of many of these parents who are telling the rhyme.

The history of the bed bug is both interesting and disturbing. The first records of bed bugs date back to ancient Egypt and Greece. There are two main bed bugs that can make for a miserable night: the common bed bug and the tropical bed bug. Before the 1940's, bed bugs were widely considered a major pest throughout the world—hence the rhyme. Around World War II however, a variety of insecticides—the most famous, or perhaps infamous of which was DDT—were invented and quickly made a serious dent in bed bug populations to the point where the parents today who say that famous rhyme have probably never seen a bed bug. Well, at least until recently.

With the banning of DDT and the increasing awareness that insecticides can have serious, long term deleterious effects for both humans and their environment, industrial strength “bug killers” are not used as widely as they were in the past. Also, as with any species, bed bugs evolve with increased resistance to insecticides, and with a pest that reproduces as quickly as bed bugs, the evolution of the species toward a more resistant bed bug can progress rapidly. As international travelers are the most common carriers of bed bugs, travelers are bringing them into international travel hub cities of the United States and from those points of infestation the bed bugs are being spread across the United States and back out to the rest of the world.

What makes the bed bug such a problem? First, bed bugs are quite small (around ¼ of an inch long at maturity), with the perfect flattened shape to fit into crevices (such as pleats in mattresses and under cushions in a sofa) so they are very hard to detect. Second, they are nocturnal, being most active between midnight and 6 AM, which is usually not the preferred time for humans to be trying to find and kill bed bugs. Third, humans bitten by bed bugs often don't realize that they have been bitten until the morning when they wake up (and the bed bugs have retreated into the safety of crevices in mattresses, sofas, etc.). Bed bugs have very sharp mouth parts that pierce the skin of the humans, and most people never wake up during the bed bug's feeding. After feeding, the bed bug moves away and finds a crevice to hide in and digest its blood meal, which, depending upon conditions can sustain the bed bug for over a year.

Another reason that bed bugs are so hard to control is that their oily skin helps them evade many chemical treatments. In addition, because they feast on human blood, it is difficult to “bait them” into ingesting a poison.

Indeed, the common state-of-the-art method of controlling bed bugs is to heat them, and their living spaces, to temperatures in excess of 121 degrees Fahrenheit for over one hour, which kills both the bed bugs and their eggs. However, this costs several thousand dollars, at present, to treat a bedbug infested house, and obviously considerably more for a hotel or apartment building.

Why is it so hard to stop the bed bug? We need look only to the bed bug life cycle to see why this pest is here to stay. A common description of a species that reproduces quickly is “they breed like rabbits”. This phrase really should be “they breed like bed bugs”, as the bed bug reproductive cycle makes rabbits look like the average nunnery in terms of reproductive restraint.

If you can ignore the painful itches that result from a night with bed bugs in your bed, you can only marvel at this reproductive machine. A female bed bug can go from an egg to a sexually mature bed bug in around three weeks. After she becomes mature, each female can lay up to twelve eggs each day. And while female bed bugs require a meal of blood to lay eggs, even without blood a bed bug can live for a long time.

While the discomfort to a human who has been bitten by bed bugs cannot be trivialized, the commercial implications and legal liabilities of a bed bug infestation are enormous. All it takes is one Trip Advisor® review complaining about bed bugs and a hotel will probably get rid of its bed bugs as there will be so few paying guests, the bed bugs will have nothing to eat and will die of starvation—but starvation could take over a year. For an apartment complex, a reputation as a place that has bed bugs can lead to huge problems remedying both the bed bug situation and the apartment complex's reputation.

There are known in the science of bed bug control various spores that contain a fungus that infects and kills bed bugs. These spores have been used in the past to kill bed bugs by combining the spores with water or oil and spraying them directly onto bed bugs. Obviously this method has its drawbacks, and no one wants their bedrooms washed down with water or oil.

A further limitation to this method is that once the spore dries out, it dies and is no longer capable of infecting a bed bug—it must be wet to germinate the fungus. So, while dry spores may be sprayed into an infested area, they can be easily “triggered” by water carelessly splashed on them, or even high humidity, and although the spores can be protected inside of a plastic bag, they only protects them in a location that is worthless in trying to accomplish the goal: of have a bed bug come into contact with a “live” spore such that it becomes infected and dies.

Although oil evaporates more slowly that water, this spray method still has the inherent limitation that this is effective only so long as the medium stays wet. Another drawback of this method is that it requires special equipment, special training to use the equipment, and can be used only by pest controllers licensed in this field. As with any spraying process, a professional grade respirator and other protective gear must be worn and there is always a potential danger to the human applicator should any of this equipment fail.

### PRIOR ART

There is considerable prior art that attempts to kill bed bugs through various insecticides. Insecticides may kill bed bugs, but still have the same inherent problem that was seen with DDT: the better the insecticide is at killing bed bugs, the more dangerous it is for non-bed bug types of life and the worse it is for the environment. The prior art also has a variety of physical traps often containing sticky surfaces, and carbon dioxide or other lures. As with any trap, it is only going to catch some of the bed bugs and considering the quick growth and reproductive capabilities of bed bugs, traps will usually only limit—not eliminate—the problem especially as the bed bugs typically infest areas inaccessible to placing traps. As a purely commercial issue, it is likely that a hotel that has bed bug traps under its beds would be shunned by guests, particularly if the guest checked a trap and found a bed bug in it. Thus, while physical traps can be effective at helping to monitor and maintain a dwelling unit, they are not a satisfactory solution to killing bed bugs and preventing bed bug infestations in the first place.

There is also prior art that teaches the use of heat to kill bed bugs. One reason why bed bugs are not such a problem in desert regions of the world is that temperatures of, depending on the source of information, between 113 and 120 degrees will kill all stages of bed bugs, from eggs to larvae to adults. Thus, Borrego Springs, Calif., where a cool summer day is only 115 degrees, does not have the problems with bed bugs that nearby Los Angeles, which only gets above 100 degrees rarely, has to endure. The current prior art calls for sealed enclosures into which heat is pumped. While this may prove effective, it requires the moving of specific equipment into an infested area for elimination of the bed bugs and can prove bulky, inefficient, and create additional risk of technicians spreading bed bugs during the process. There is also the danger that during the removal of, say, a sofa, bed bugs or their eggs could fall off the sofa as it is being moved, and then move right back into the “sanitized” environs to once again re-infest the sofa once it is returned from the heat chamber.

Thus, there has existed a long-felt need for an effective means by which bed bugs can be killed. It should be understood that “living unit” is a term that is intended to encompass single family homes, multi-unit buildings such as hotels and apartments, cruise ships, airplanes, busses, theaters, delivery vehicles—basically anywhere that a bed bug could live or hitch a ride.

### OBJECTS OF THE INVENTION

It is therefore an object of the present invention to provide a method by which bed bugs can be killed over a long period of time.

It is another objection of the invention to provide a pearl that contains both a spore fatal to bed bugs and a selectively released into the body of bed bugs.

### BASIC SUMMARY OF THE INVENTION

The basic goal of this invention is to protect a spore containing a bed-bug-killing fungus such that the spore can be placed in an area frequented by bed bugs such that a bed bug touching the spore will activate it, thereby growing the fungus that will then kill the bed bug.

One embodiment of this invention is to kill bed bugs through a liposomal delivery of a deadly (to bed bugs) strain called Beauveria bassiana Strain GHA, in the form of spores, to bed bugs.

Bed Bugs are very susceptible to the fungus Beauveria bassiana, however the spore of this fungus is easily destroyed by germination without being attached to a host insect. Thus, it is the goal of this invention to cause more of these deadly spores to germinate while attached to the bed bug. Even too much moisture in the air can start the germination process giving the spore a short life of only a few days.

This life span can be dramatically increased by storing the spores in evaporated oil. The low water content in the oil along with the oil protecting the spore from the elements greatly increases the spore's life to 1 to 2 years. However, in this form it is inefficient and unsightly to apply oil directly to surfaces in a home to target bed bugs. Also, standard pest control equipment mostly relies on water-based, pressurized sprayers to apply pesticides to the environment in which bed bugs live. This would mean that with current commonly used equipment, Beauveria bassiana would be exposed to the water, thereby rendering it ineffective within days of application. Considering that an average of two months of residual treatment is needed to be effective in a successful bed bug extermination, the life of the spore must be protected by additional human intervention through a process of delivery that will protect the spore and yet not leave unsightly residues (such as oil stains) on the furniture or floor of the area being treated. By making micro-encapsulated oil droplets with either single or multiple layers of “protection”, the spore can be safely delivered to the bed bug over a period of several months after application.

The theory behind this invention is that by making an outer layer to be protective and water resistant (as opposed to waterproof), and an inner layer that is susceptible to being crushed by a bed bug walking over it. Even though bed bugs are tiny insects, if the inner layer is made weak enough, the mere scraping of a bed bug's underside over the spore, grinding it against the floor, will be sufficient to crush the inner layer, whereupon the spore will adhere itself to the oily body of the bed bug, germination, and eventually kill the bed bug.

The spore itself will be added to a dry oil, thereby extending its life by years rather than the current lifespan of hours or days. The oil will be divided into small droplets in the micron size mostly likely through a process of spray microencapsulation with a poly or other process that would create a hard shell around lipid that is breakable by bed bug activity. This creates the pearl. In order to protect the pearl from being broken during transit and maintain its integrity a thick dissolvable coating will be added to the pearl. The final product will just be a dry granular formulation, to which water can be added to prepare the product for spraying.

The dry product can be sold to consumers, who will add water to the granulated pearl powder to get it ready for application. The outer coating will dissolve upon being dumped into a container of water, leaving the pearl exposed to the water. The resulting product must be applied with one hour of mixing, such that the lipid will still being dry enough to protect the spores it contains.

The end result is a method of applying spores to an environment with the use of standard water-based pump sprayers that are commonly used in pest control and available at most home stores, without the current environmental and health concerns, and at considerably less cost. The two-layer coating is effective in still allowing protection of the spore from the natural world of humidity and keeping the spore in a dry type of environment as long as the shell of the pearl is not broken.

The theory behind one embodiment of this invention is to employ liposomal encapsulation to allow the hydrophobic/lipophilic Beauveria bassiana Strain GHA or other strains of Beauveria bassiana spores to be delivered in an aqueous delivery system while protecting the spores from being exposed to water. The spore is suspended in an oil that has been dried of most of its water content. The liposomes are composed of a phospholipid surfactant that encapsulates the lipophilic/hydrophobic carrier and the spores inside the surrounding phospholipid layer that is arranged with the lipophilic/hydrophobic tail surrounding the spore with infused oil and the hydrophilic head facing the aqueous outer environment.

The liposomes will be dispersed in the aqueous carrier in a stable system that will have 12-to-24-month shelf-life. The liposomal system will be sprayed inside the contaminated area and will deposit the lipid droplets containing the active spores which will be subsequently adsorbed onto the bedbugs after they pass over the spores. FIG. 1 gives a general picture of a liposome particle with the carrier and the spores entrapped in the central portion of the circle. As the bed bug passes over lipids, they are easily broken by the bug activity. This exposes the bug to the oil that is infused with Beauveria bassiana spores. The cuticles of the bedbug naturally wick oil into them, allowing the spore to be delivered efficiently.

It is common knowledge that Beauveria bassiana is toxic to insects and will result in mortality. The goal here is to provide a method of delivery of the spore through common water-based sprayers used in the pest control industry as a delivery method without getting Beauveria bassiana wet. When exposed to water, the spore will germinate and dies.

Another purpose is that you could use an oil-only suspension as used in the Apperhend product. However, this leaves unsightly wet looking residue of oil on surfaces. Also, primary location bed bugs are found on are fiber type surfaces for example beds and couches. The oil if not encapsulated will wick into the fiber leaving the spore on the surface exposed to the environment causing treatments to most important areas less effective. Also, the encasement will protect against humidity which is listed on Apperhend's label will reduce the life of the effectiveness of the product. The oil will absorb water from humidity, causing the spores to germinate before finding a host. Using the encapsulation method is the only way that makes sense for a long-lasting product with a long-lasting residual in an infested environment.

There are a number of different embodiments contemplated, as can be seen in FIG. 1. The general concept is that an outer polymer holds pearl together after drying. The bigger the pearl, that easier it is to break as the bed bug walks over it, at which point the spore escapes and infects the bedbug.

In yet another embodiment, the formulation is a dry formulation of a microencapsulated spore. This spore can either be directly encapsulated or saturated in an oil then encapsulated. The spore can be in one or more encapsulated layers to create a controlled delivery of the spore without damaging them or exposing them to the elements greatly increasing their lifespan. The inner coating is resistant to water to seep through will have a rate of seepage. Coating thickness will play a key part by greatly reducing or fully eliminating the amount of water can reach the spore during the application process and protect it from short exposures to water such as accidental water spillage, humidity, or brief rain fall. The inner coating is sticky too and breaks down on oily surfaces. This would allow the spore to wait until a bug that is naturally oily crosses over it.

In this embodiment, the inner coating is sticky too surfaces that are oily so when a bug or specifically in this case a bed bug crosses over the treated area their body can be covers in hundreds of encapsulated spores. The layer will break down on an oily surface exposing the spore to the surface of the bug. Specifically for bed bugs they have a higher rate of oily skin then other common bugs making them even more susceptible to the spore. The same oily skin they use to protect them from chemicals is being used against them in this process.

A second encapsulated layer can be chosen to be used. This coating is for protecting the inner coating from damage during transit and handling. This coating will act as the body armor of the package. This inner coating can ware against each other and expose the spore by adding this much thicker second coating this will allow this ware over a much greater time. This outer coating will strip off soon as it is introduced to water and when sprayed and dry will be invisible to the eye.

The spore will be added to a dry oil with an analogue of cyclodextrin such as HPBCD (hydroxypropyl beta-cyclodextrin) then hydrogenizes. This encapsulation process we will call (spore infused encapsulated hydrogenation) SIEH for short. The process of SIEH is not reflected in prior art. What separates SIEH from Encapsulated Hydrogenation is with infusing spores. The characteristics of the SIEH capsules is that it creates conditions for the spore to preserve the spore in dry and wet environments and that they stick to surfaces and other oily bodied insects.

SIEH capsules can be easily transferred from environmental surface to an oily surface since the SIEH capsules contain oil. SIEH capsules break down on oily surfaces exposing the spore to insect at the correct time with fatal consequences. SIEH capsules provide a protection for the spores by keeping them out contained without access to air. SIEH capsules provide protection for spores by protecting the spores from water for short durations of time. SIEH capsules provide protection from mixing in water in a pump sprayer. SIEH capsules provide protection from humidity that is known to shorten life span of spores SIEH capsules provide protection from rainwater that will dry within hours.

By utilizing existing encapsulation methods, a spore can be infused into these methods as a way of protecting from environmental conditions that would normally kill them. By utilizing an encapsulation method such as SIEH spores can be delivered though industry standard application methods such as a product infused with Encapsulated spores, a wettable power that can be sprayed into an environment and dried, or a powder that can be applied directly without getting the powder wet.

SIEH and other encapsulation methods can be utilized to deliver spores to insects. SIEH and other encapsulation methods can be utilized to protect spores increasing the time period after application that they remain active in an environment that spore would normally not live long in. SIEH and other encapsulation methods is a process of delivery of spores over longer durations of time to insects indoors.

Another embodiment features a microencapsulated powder that contains spores in the capsules that is designed to protect spores from the environment during several types of application types such as applying the power directly, mixing in water sprayers, or applied as a coating to a product that can be placed into an environment such as on the back side of a tape that can be applied in a environment. Encapsulation protects spores and extends life expectancy spores to be used as an effective long term residual treatment or insect treatment and prevention.

In yet another embodiment, the bed bugs are killed by a microencapsulated powder that contains spores that is sticks to oily surfaces such as to insects. The encapsulation coating breaks down on oily surface to expose the spore to the surface of an incest specifically its cuticles as a form of delivery method to insects.

It should be noted that a variety of encapsulation method can be used, with the basic idea that an encapsulation method protects the spore using an oil-based method into a dry power formulation that protects the spores from the environment but is sticky too and breaks down on other oily surfaces. The goal of this method is to provide a dry formulation of a microencapsulated spore that is designed to target insects and formulated to protect the spore during transport, water, and from the elements. The spore can be directly encapsulated or saturated in oil, then encapsulated.

It is contemplated that the spore could be one or more layers to create a controlled delivery of the spore without damaging the spore or exposing them to the elements that would greatly increase the spore's lifespan. The goal would be to provide an inner coating that is resistant to water to seep through. However seepage cannot be stopped there is a rate of seepage. Coating thickness will play key part of greatly reducing or fully eliminating the amount of water that can reach the spore during the application process with standard water sprayers. This layer will also protect the spore from short exposure to water after the application process for example spillage, humidity or brief rain fall.

Inner coating is sticky too surfaces that are oily so when a bug or specifically in this case a bed bug crosses over the treated area their body can be covers in hundreds of encapsulated spores. The layer will break down on an oily surface exposing the spore to the surface of the bug. Specifically for bed bugs they have a higher rate of oily skin then other common bugs making them even more susceptible to the spore. The same oily skin they use to protect them from chemicals is being used against them in this process.

A second encapsulated layer can be chosen to be used. This coating is for protecting the inner coating from damage during transit and handling. This coating will act as the body armor of the package. This inner coating can ware against each other and expose the spore by adding this much thicker second coating this will allow this ware over a much greater time. This outer coating will strip off soon as it is introduced to water and when sprayed and dry will be invisible to the eye.

One possible process is hydrogeneration; the same method that is used in powdered coffee creamer. It introduces oil to a product without separation in a powdered formulation. The maker of the bed bug killing products would take a dry oil, add spores into it then hydrogenating it to keep the spore safe from the water mixture for application process for a period of several hours to several days.

This would be even though there might be a process that can be realized that is multi-layer that we would want to mention this process is a single layer microencapsulation process that protects the spore in all stages of its delivery to an insect. Storage, transit, mixing in water, spraying using standard water sprayer, drying to a surface, residual active time, and contraction onto incest body.

Insects are naturally oily especially bed bugs and cockroaches. The hydrogenated oil is resistant to water however breaks down with oil exposing whatever it contains to the environment. Being the insect in oily the hydrogenizes spores will be released or exposed to that oiled surface. In the case of this spore, it will be a food source it will start to germinate on. The germination process of this spore on an incest will ultimately infect the entirety of the bug leading to its death. It is also known that when infected more spores will grow on the surface of the bug making it contagious to other bugs and that bed bugs congregate in nest and one infected bug would then infect the of the nest.

Bed bugs take weeks to establish breeding in a new infestation. Females are pregnant and when they have hitchhiked, they will then get blood to start her process of laying eggs. It will take 6-7 weeks to become mature enough given a good food source to be mature enough to breed.

This product is not a pesticide. It does not contain any chemical active intrigants. This product is a bioinsecticide so the rules laid out be governing agencies of requiring a licensed identification of a pest to apply this product indoors does not apply. Allowing this product to be used as prevention in doors.

Hotels are constantly dealing with trying to catch bed bugs infestations before they get out of control and be seen by customers. Due to the high volume of people that stay short periods of time these environments are hubs for highs rates of transfer. A prevention system in hotels such as this product that kills the infestation before in can reach sexual reproduction would prevent hitchhiking of pregnant females. This would then eliminate one of the most problematic ways bed bugs transfer. With residual treatments lasting many months to as long as a year this will make it a cost-effective way for a hotel to manage and prevent bed bugs and cockroaches.

This product is designed to be able to use standard water spraying equipment such as sprayers and farm equipment. This product can withstand water for short periods of time such as rainfall. This product can be used in agriculture to be sprayed on to plants and last as a residual for months instead of days like other products using this spore.

It known that hydrogenated oil breaks down when introduced to an oily surface. However, by adding spores to the hydrogenated oil will work as a delivery method for the spore that was previously not known that breaks down at the right time. The right time is on the bug that is oily. I no other time in the process is the encapsulated spore introduced to an oily surface intentionally except in when a bug transverses the treated area.

Hydrogenizes oil powder naturally sticks to oily surfaces. This aids in effective delivery of the spore to the oily surface of an insect. Since the indoor environment around beds and couches normally stays dry the hydrogenizes oil containing spores can last month or even years without degradation. Since it takes about 10 days to 2 weeks for these spores to kill bed bugs, there is plenty of time for an infected bed bug to pass on the fungus to other bed bugs before it dies.

Hydrogenation is a chemical reaction between hydrogen and another compound, usually in the presence of a catalyst. In the current invention, it is used to introduce oil a hydrogen gas. It is diffused into the oil that starts to produce hydrogenizes oil powder. Anything that was mixed into the oil will be contained within it and protected. This will keep it dry until introduced to a host insect or saturated in water for a long enough time or introduced to any type of oil.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is several views of some of the pearls used to enclose a deadly spore with a capsule that would selectively release the spore at an optimum time.

FIG. 2 side view of a bed bug exterminator spraying a large number of pearls under a bed.

FIG. 3 is a side view of some spores being put into a solution prior to creation of the pearls.

FIG. 4 is a cross sectional view of a spore capsule.

FIG. 5 is a side view of a bed bug walking over some pearls

FIG. 6 is a side view of a bed bug becoming infected with the spore.

FIG. 7 is a side view of a bed bug which has died of the spore.

FIG. 8 is a perspective view of some wettable powder that is used in creating the invention.

FIG. 9 is a perspective view of a pile of application powder.

FIG. 10 is a perspective view of a powdered adhesive strip that have been infused with powder containing the spores that are fatal to bed bugs.

FIG. 11 is a perspective view of the contents of the spore-carrier mixture being put into a mixing reservoir in preparation for being sprayed in a bedbug infested area, or into an area where the user of the invention wishes to prevent future bed bug infestations.

FIG. 12 is a front view of spore-containing powder being applied to a wall socket.

FIG. 13 is a perspective view of a bed being protected with lines of adhesive tape infused with bed bug-killing powder.

FIG. 14 is a perspective view of the edges of a room being inoculated with a spore/carrier mixture.

FIG. 15 is a perspective view of a healthy bed bug crossing a treated area and becoming infected by the spores.

FIG. 16 is a perspective view of a healthy bed bug crossing a strip of powdered adhesive tape and becoming infected by the spores.

FIG. 17 is a perspective view of the creation of a hydrogenated dry oil/spore composition in preparation for spraying.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

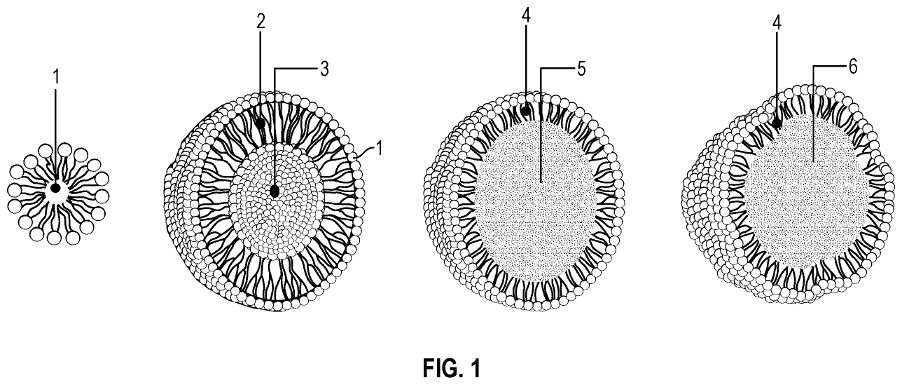

FIG. 1 is several views of some of the pearls used to enclose a deadly spore with a capsule that would selectively release the spore at an optimum time. In one version, a hydrophobic core 1 keeps water away from the spore protected inside. In a second figure, a lipid bilayer 2 protects a liquid aqueous core 3. In yet another embodiment, a surfactant monolayer 4 protects a liquid lipid core, and a solid lipid core 5.

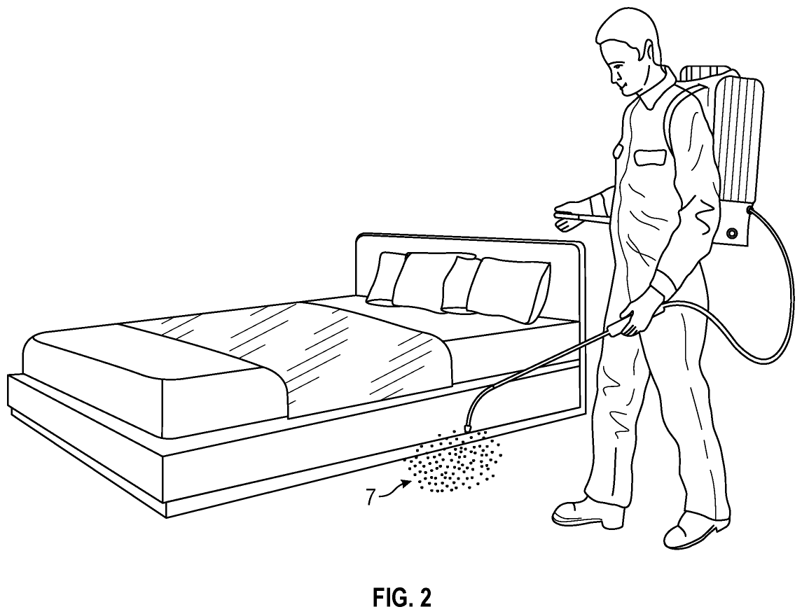

FIG. 2 side view of a bed bug exterminator spraying a large number of pearls in a spore/liquid mixture 7 under a bed through a commercial sprayer.

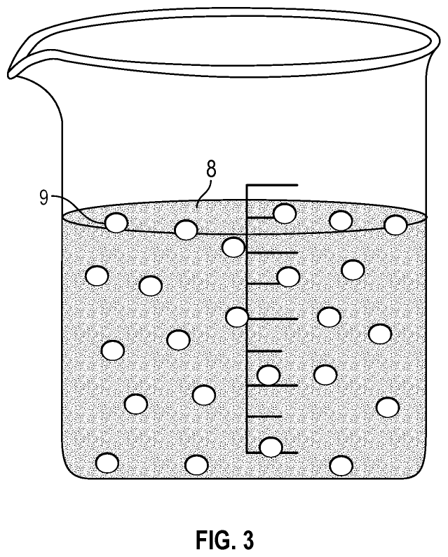

FIG. 3 is a side view of some spores 9 being put into a solution 8 prior to creation of the pearls.

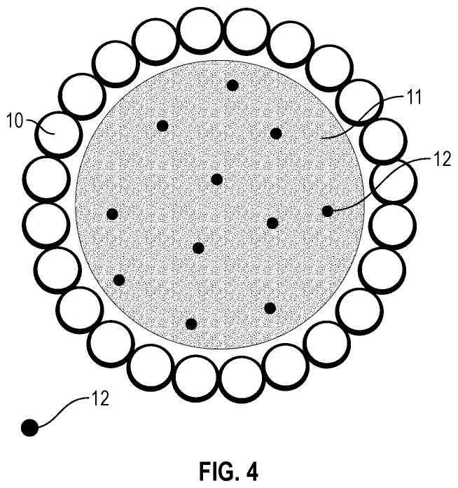

FIG. 4 is a cross sectional view of another embodiment of the spore capsule. In this figure, a carrier solution 12 carries the spore to a spore-infused lipid 11, that is held and protected by a microencapsulation wall 10.

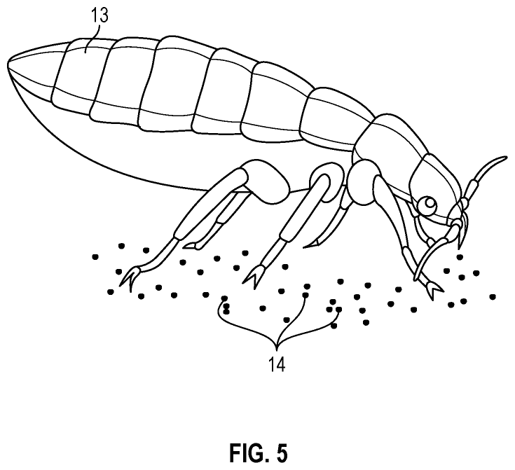

FIG. 5 is a side view of a bed bug 13 walking over some pearls 14. While bed bugs may seem small to the human eye, they are relatively huge (and heavy) when compared to the pearls, and in between the pearls sticking to the bed bug's oily skin, and the pearls that are crushed by the bed bug walking on them, plenty of the spores make their way onto the bed bug's skin, where they germinate and the resulting fungus kills the bed bug.

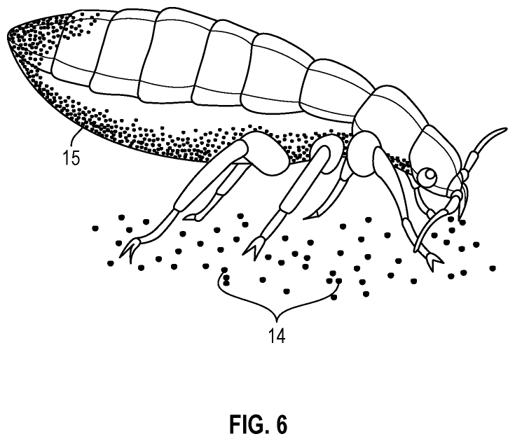

FIG. 6 is a side view of a bed bug becoming infected with the spores 14. Since it takes the bed bug a week or two to die from the fungus, the infected bed bug 15 has plenty of time to interact with other bed bugs and pass on the fungus to them.

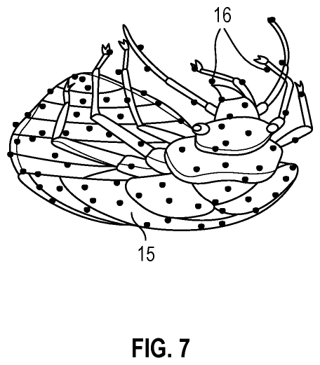

FIG. 7 is a side view of a bed bug that has died of the activated spores 16. Since the spores are not activated until the bed bugs walk over them, the “hibernating” spores can survive for years, just waiting for a bed bug to walk by and contact them.

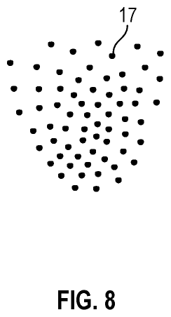

FIG. 8 is a perspective view of some wettable powder 17 that is used in creating the invention.

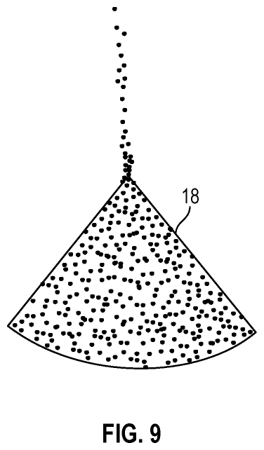

FIG. 9 is a perspective view of a pile of application powder 18.

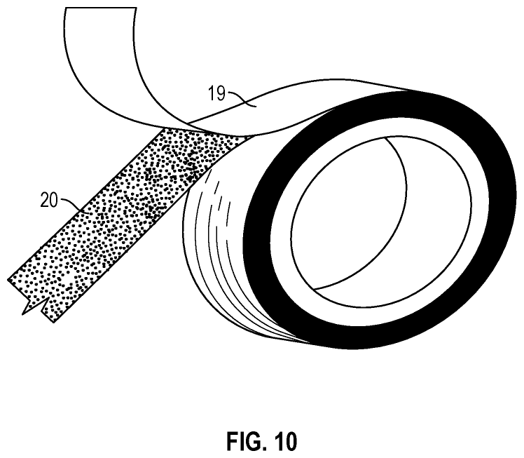

FIG. 10 is a perspective view of a powdered adhesive strip 20 that has been infused with powder 20 containing the spores that are fatal to bed bugs.

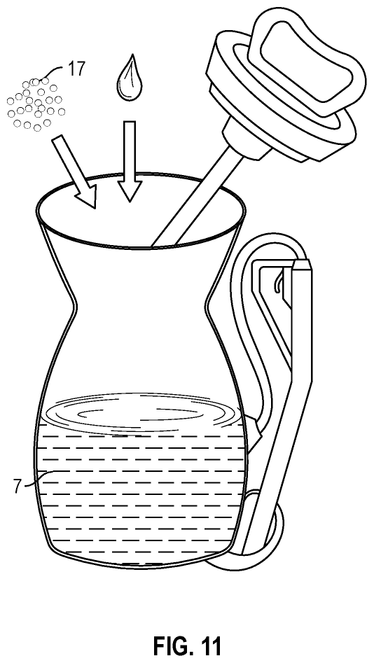

FIG. 11 is a perspective view of the contents of the spore-carrier mixture being put into a mixing reservoir in preparation for being sprayed in a bedbug infested area, or into an area where the user of the invention wishes to prevent future bed bug infestations. A wettable powder 17 is mixed with water in a conventional sprayer, creating the spore/liquid mixture 7, which is then applied to an area infested with bed bugs, or as a preventative measure to an area where the user is concerned about future infestations.

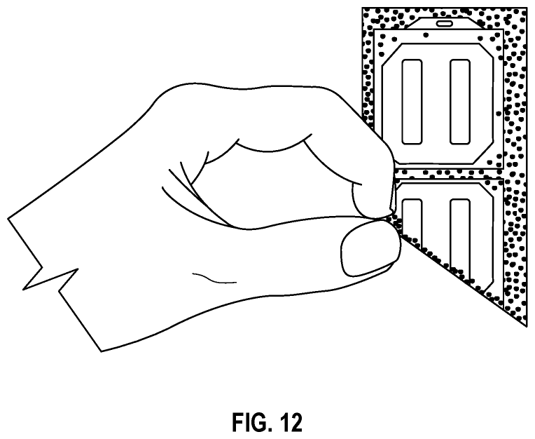

FIG. 12 is a front view of spore-containing powder being applied to a wall socket.

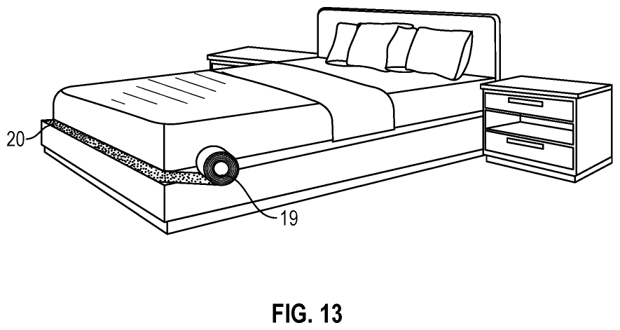

FIG. 13 is a perspective view of a bed being protected with lines of adhesive tape 19 infused with bed bug-killing powder 20. By laying lines of this tape around a mattress, bed bugs which come out from their daytime hiding places will be infected as they cross over the lines of tape. Since bed bugs like to hide in narrow, dark crevasses, the adhesive tape 19 is very effective in creating a fatal barrier between the bed bugs' daytime hideout, and the people sleeping on top of the mattress.

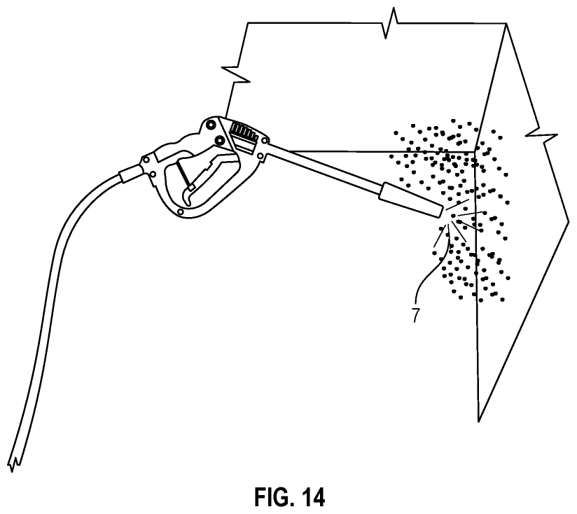

FIG. 14 is a perspective view of the edges of a room being inoculated with a spore/carrier mixture 7.

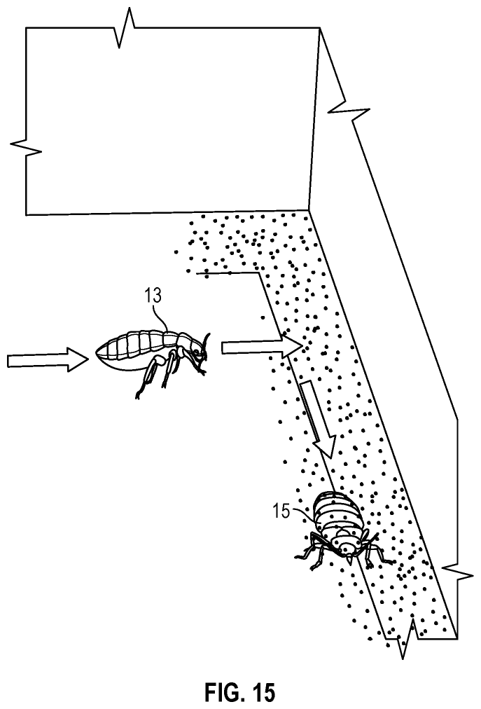

FIG. 15 is a perspective view of a healthy bed bug 13 crossing a treated area and becoming infected by the spores. Once the bed bug crosses the treated area, it becomes infected, and the infected bed bug 15 will then spread the fungus to other bed bugs it comes into contact with.

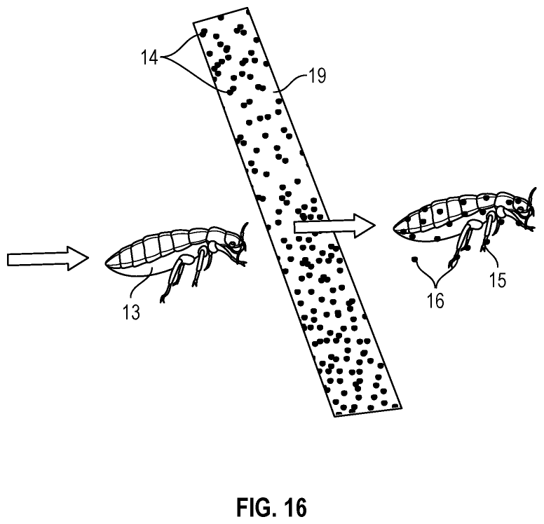

FIG. 16 is a perspective view of a healthy bed bug 13 crossing a strip of powdered adhesive tape 19 and becoming infected 16 by the spores 14 that were inactive until the bed bug crossed over them, at which point they stuck to the bed bug's skin and became activated spores 16. As with the other embodiments of this invention, once the bed bug crosses the treated area, it becomes infected, and the infected bed bug 15 will then spread the fungus to other bed bugs it comes into contact with until it dies one or two weeks later.

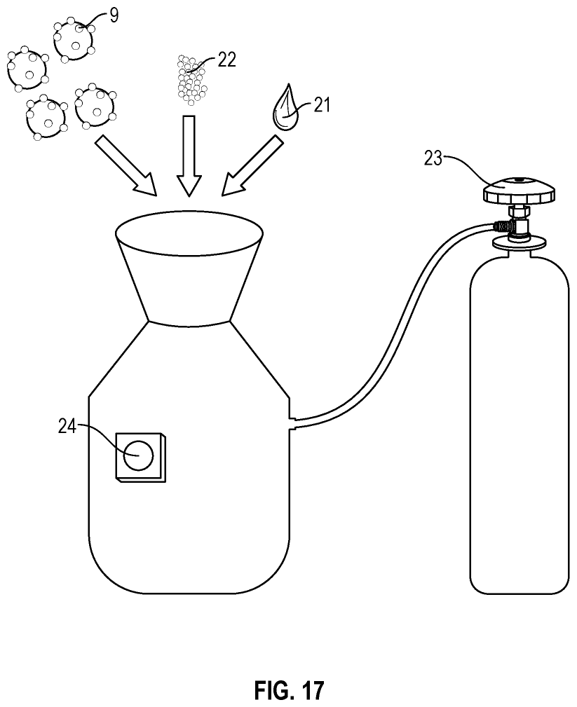

FIG. 17 is a perspective view of the creation of a hydrogenated dry oil/spore composition in preparation for spraying. A solution of spores 9, sugar 22 and dry oil 21 is heated with hydrogen gas 23 to create a spore infused hydrogenated encapsulation 24. This provides a pearl with a water-resistant outer shell with an easily crushed inner shell, such that the mixture can be sprayed anywhere, but the spores will not be activated until broken by a bed bug or until they attach the oily skin of a bed bug.

The basic goal of this invention is to kill bed bugs through a liposomal delivery of a deadly (to bed bugs) strain called Beauveria bassiana Strain GHA, in the form of spores, to bed bugs.

Bed Bugs are very susceptible to the fungus Beauveria bassiana, however the spore of this fungus is easily destroyed by germination without being attached to a host insect. Thus, it is the goal of this invention to cause more of these deadly spores to germinate while attached to the bed bug. Even too much moisture in the air can start the germination process giving the spore a short life of only a few days.

This life span can be dramatically increased by storing the spores in evaporated oil. The low water content in the oil along with the oil protecting the spore from the elements greatly increases the spore's life to 1 to 2 years. However, in this form it is inefficient and unsightly to apply oil directly to surfaces in a home to target bed bugs. Also, standard pest control equipment mostly relies on water-based, pressurized sprayers to apply pesticides to the environment in which bed bugs live. This would mean that with current commonly used equipment, Beauveria bassiana would be exposed to the water, thereby rendering it ineffective within days of application. Considering that an average of two months of residual treatment is needed to be effective in a successful bed bug extermination, the life of the spore must be protected by additional human intervention through a process of delivery that will protect the spore and yet not leave unsightly residues (such as oil stains) on the furniture or floor of the area being treated. By making micro-encapsulated oil droplets with either single or multiple layers of “protection”, the spore can be safely delivered to the bed bug over a period of several months after application.

The theory behind this invention is to employ liposomal encapsulation to allow the hydrophobic/lipophilic Beauveria bassiana Strain GHA or other strains of Beauveria bassiana spores to be delivered in an aqueous delivery system while protecting the spores from being exposed to water. The spore is suspended in an oil that has been dried of most of its water content. The liposomes are composed of a phospholipid surfactant that encapsulates the lipophilic/hydrophobic carrier and the spores inside the surrounding phospholipid layer that is arranged with the lipophilic/hydrophobic tail surrounding the spore with infused oil and the hydrophilic head facing the aqueous outer environment.

The liposomes will be dispersed in the aqueous carrier in a stable system that will have 12-to-24-month shelf-life. The liposomal system will be sprayed inside the contaminated area and will deposit the lipid droplets containing the active spores which will be subsequently adsorbed onto the bedbugs after they pass over the spores. FIG. 1 gives a general picture of a liposome particle with the carrier and the spores entrapped in the central portion of the circle. As the bed bug passes over lipids, they are easily broken by the bug activity. This exposes the bug to the oil that is infused with Beauveria bassiana spores. The cuticles of the bedbug naturally wick oil into them, allowing the spore to be delivered efficiently.

It is common knowledge that Beauveria bassiana is toxic to insects and will result in mortality. The goal here is to provide a method of delivery of the spore through common water-based sprayers used in the pest control industry as a delivery method without getting Beauveria bassiana wet. When exposed to water, the spore will germinate and dies.

Another purpose is that you could use an oil-only suspension as used in the Apperhend product. However, this leaves unsightly wet looking residue of oil on surfaces. Also, primary location bed bugs are found on are fiber type surfaces for example beds and couches. The oil if not encapsulated will wick into the fiber leaving the spore on the surface exposed to the environment causing treatments to most important areas less effective. Also, the encasement will protect against humidity which is listed on Apperhend's label will reduce the life of the effectiveness of the product. The oil will absorb water from humidity, causing the spores to germinate before finding a host. Using the encapsulation method is the only way that makes sense for a long-lasting product with a long-lasting residual in an infested environment.

There are a number of different embodiments contemplated, as can be seen in FIG. 1. The general concept is that an outer polymer holds pearl together after drying. The bigger the pearl, that easier it is to break as the bed bug walks over it, at which point the virus escapes and infects the bedbug.

The general concept is to provide a compound for delivery of a spore to a bed bug, comprising: a spore and a covering, where, the spore has an inactive state and an active state, where the active state is caused by contact with a bed bug, where the spore in the active state creates a fungus, where the fungus kills the bed bug, where the covering comprises a water-resistant outer layer, and a delicate inner layer, such that the active state is not triggered until the bed bug comes into contact with the compound, where the delicate inner layer can be broken by the weight of an average bed bug, where the spore is attracted to oily surfaces, where the bed bug has an oily skin, and where the spore is capable of adhering to the oil skin of the bed bug, additionally comprising a core, where the core is a liquid lipid core, where the compound additionally comprises a carrier.

The spore can be a wettable powder and the carrier can be water, or the carrier can be a combination of sugar and dry oil, where the spore, the sugar and the dry oil are heated, where hydrogen gas is added to the compound, and where a spore infused hydrogenated encapsulation is created.

It is also contemplated that the same technology can be used in an adhesive tape for the control of bed bugs, comprising a strip of adhesive tape and an exposed powder, where the strip of adhesive tape is infused on a top side with the exposed powder, where the exposed power comprises a spore and a covering, where, the spore has an inactive state and an active state, where the active state is caused by contact with a bed bug, where the spore in the active state creates a fungus, where the fungus kills the bed bug.

In a preferred embodiment, the spore is Beauveria bassiana Strain GHA, although other spores capable of directly or indirectly killing bed bugs are contemplated.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### REFERENCE NUMBERS USED

1. Hydrophobic core.
2. Lipid bilayer
3. Liquid aqueous core
4. Surfactant monolayer
5. Liquid lipid core
6. Solid lipid core
7. Spore/liquid mixtures
8. Solution
9. Spore
10. Microencapsulation Wall
11. Spore-infused lipid
12. Carrier Solution
13. Bed Bug
14. Inactivated spores
15. Infested Bed Bug
16. Activated spores
17. Wettable powder
18. Pile of Application powder
19. Powdered adhesive strip
20. Exposed powder
21. Dry oil
22. Sugar
23. Hydrogen gas
24. Spore infused hydrogenated encapsulation

That which is claimed:

1. A compound for delivery of a spore to a bed bug, consisting of: a spore and a covering, where, the spore has an inactive state and an active state, where the active state is caused by contact with a bed bug, where the spore in the active state creates a fungus, where the fungus kills the bed bug, where the covering comprises a water-resistant outer layer, and a delicate inner layer, such that the active state is not triggered until the bed bug comes into contact with the compound, where the delicate inner layer can be broken by the weight of an average bed bug, where the spore is attracted to oily surfaces, where the bed bug has an oily skin, and where the spore is capable of adhering to the oil skin of the bed bug, additionally comprising a core, where the core is a liquid lipid core, where the compound additionally comprises a carrier.

2. The compound of claim 1, where spore is a wettable powder and the carrier is water.

3. The compound of claim 1, where the carrier is a combination of sugar and dry oil, where the spore, the sugar and the dry oil are heated, where hydrogen gas is added to the compound, and where a spore infused hydrogenated encapsulation is created.

4. The compound of claim 1, additionally comprising an adhesive tape for the control of bed bugs, comprising a strip of adhesive tape and an exposed powder, where the strip of adhesive tape is infused on a top side with the exposed powder, where the exposed power comprises a spore and a covering, where, the spore has an inactive state and an active state, where the active state is caused by contact with a bed bug, where the spore in the active state creates a fungus, where the fungus kills the bed bug.

5. The compounds of claim 1, where the spore is Beauveria bassiana Strain GHA.

6. A compound for delivery of a spore to a bed bug, comprising: a spore and a covering, where, the spore has an inactive state and an active state, where the active state is caused by contact with a bed bug, where the spore in the active state creates a fungus, where the fungus kills the bed bug.

7. The compound of claim 6, where the covering comprises a water-resistant outer layer, and a delicate inner layer, such that the active state is not triggered until the bed bug comes into contact with the compound.

8. The compound of claim 7, where the delicate inner layer can be broken by the weight of an average bed bug.

9. The compound of claim 8, where the spore is attracted to oily surfaces, where the bed bug has an oily skin, and where the spore is capable of adhering to the oil skin of the bed bug.

10. The compound of claim 9, where the spore is Beauveria bassiana Strain GHA.

11. The compound of claim 9, where the outer layer is hydrophobic and the inner layer is surfactant monolayer.

12. The compound of claim 11, additionally comprising a core, where the core is a liquid lipid core.

13. The compound of claim 11, additionally comprising a core, where the core is a solid lipid core.

14. The compound of claim 9, where the compound additionally comprises a carrier.

15. The compound of claim 14, where spore is a wettable powder and the carrier is water.

16. The compound of claim 15, where the compound can be applied using a traditional sprayer.

17. The compound of claim 14, where the carrier is a combination of sugar and dry oil, where the spore, the sugar and the dry oil are heated, where hydrogen gas is added to the compound, and where a spore infused hydrogenated encapsulation is created.

18. The compound of claim 17, where the compound can be applied using a traditional sprayer.

19. The compound of claim 6, additionally comprising an adhesive tape for the control of bed bugs, comprising a strip of adhesive tape and an exposed powder, where the strip of adhesive tape is infused on a top side with the exposed powder, where the exposed power comprises a spore and a covering, where, the spore has an inactive state and an active state, where the active state is caused by contact with a bed bug, where the spore in the active state creates a fungus, where the fungus kills the bed bug.

20. A device for the liposomal delivery of Beauveria bassiana Strain GHA spores to bed bugs, comprising: a spore of a strain of Beauveria bassiana, and a pearl coating, where the peal coating protects the spore from water, and where the pearl coating releases the spore upon breaking, thereby infecting a bed bug.
